(19) United States
(12) Patent Application Publication
(10) Pub. No.: US 2016/0283827 A1
(43) Pub. Date: Sep. 29, 2016

(54) Print Controller and Printing Apparatus

(71) Applicant: Seiko Epson Corporation, Tokyo (JP)

(72) Inventor: Tomohiko Sano, Shiojiri-shi (JP)

(21) Appl. No.: 15/080,080

(22) Filed: Mar. 24, 2016

(30) Foreign Application Priority Data
Mar. 26, 2015 (JP) 2015-064629

(51) Int. Cl. G06K 15/02; G06K 15/00; H04N 1/00

(52) U.S. Cl. CPC G06K 15/1802; H04N 1/00474; G06K 15/4045; G06K 15/1805; G06K 15/1819; H04N 1/00472; H04N 2201/0094

(57) ABSTRACT

A controller of a printing apparatus includes a print setter configured to change a printing condition, a UI that receives a change of a printing condition made by the print setter, and a display controller that outputs the printing condition to the UI. The display controller changes a display form of at least one of a setting item and a setting value of the changed printing condition in accordance with elapsed time from the time when the printing condition was changed by the print setter.

### CROSS-REFERENCE TO RELATED APPLICATION(S)

This application claims priority under 35 U.S.C. §119 on Japanese Patent Application No. 2015-064629, filed Mar. 26, 2015. The content of this priority application is incorporated by reference in its entirety.

### BACKGROUND

1. Technical Field

The present invention relates to a print controller and a printing apparatus.

2. Related Art

In a conventional printing apparatus, a printing condition such as printing quality, media type, color or monochrome, and the like is set by a user, and printing is performed on a medium based on the set printing condition. Such a printing apparatus includes a print controller as a printer driver and communicates information of a printing condition with a user's operating terminal through a user interface that causes a print setting window used for setting a printing condition to be displayed on the operating terminal, for example (see, for example, JP-A-2004-326658).

In a printing apparatus of JP-A-2004-326658, when a setting value of a setting item in a printing condition is changed, the changed setting value of the setting item is highlighted in reverse video to allow a user to know that the setting value of the setting item has been changed.

A printing apparatus in which a printing condition can be changed from a plurality of operating terminals via a network is known. In such a printing apparatus, there may be a situation where, besides a change of a printing condition made by a certain user, a change of a printing condition by a different user is reflected in the printing apparatus. In such a case in the printing apparatus of JP-A-2004-326658, although the user can rely on the display form of a setting value to know that the setting value of some setting item has been changed, it is difficult for the user to determine whether the change is due to a change made by the user himself/herself or due to a change made by a different user.

### SUMMARY

An advantage of some aspects of the invention is that a print controller and a printing apparatus that enable a user to easily determine whether or not a change of a setting item has been changed by the user himself/herself are provided.

In the following, solutions to the above problems and their effects and advantages will be described.

A print controller according to an aspect of the invention includes: a print setter configured to change a printing condition to a changed printing condition; a receiver that receives the changed printing condition; and a display controller that outputs the changed printing condition to the receiver, and the display controller changes a display form of at least one of a setting item and a setting value of the changed printing condition in accordance with elapsed time from time when the printing condition was changed by the print setter.

A user that changed a printing condition is likely to remember the date and time at which the user changed a printing condition by the user himself/herself. Therefore, with being able to identify that a printing condition was changed at a different date and time from the date and time when the user changed the printing condition by the user himself/herself, the user can determine whether the printing condition was changed by the user himself/herself or by another user.

In this regard, according to the configuration described above, since a display form of at least one of a setting item or a setting value in a printing condition is changed in accordance with the elapsed time, the user is able to identify when the setting item or the setting value was changed. Therefore, when a setting value of a setting item in a printing condition has been changed, the user is able to easily determine whether the change was made by the user himself/herself or by another user.

Further, in the print controller described above, the display controller may preferably indicate at least one of a setting item and a setting value of the printing condition by characters and change the display form of at least one of color of the characters, a thickness of the characters, a background color of the characters, a font type of the characters, and a font size of the characters in accordance with the elapsed time.

According to the configuration described above, the color of characters or the like or a background color of the characters of at least one of a setting item and a setting value in a printing condition is changed. This enables the user to intuitively identify when the setting value of the setting item in the printing condition was changed, compared to the case where a date and time of change of a setting value of a setting item in a printing condition is indicated by the user's selection of the setting item or the setting value in the printing condition, for example.

Further, in the print controller described above, the printing condition may preferably be formed of layered setting items, and, if a setting value of a setting item in a lower layer of the printing condition is changed by the print setter, the display controller may change a display form of at least one of the setting item and the setting value in the lower layer and a display form of a setting item in a top layer of the printing condition.

if a setting value of a setting item in a lower layer in the printing condition is changed and unless the display form of the setting item in an upper layer in the printing condition were changed, the user would be likely to finish its setting operation of the printing condition without knowing the change of the setting value of the setting item in the lower layer in the printing condition.

In this regard, if a setting value of a setting item in a lower layer in a printing condition is changed, since the display form of the setting item in the top layer is changed along with the changed display form of the setting item and the setting value in the lower layer, the user can be informed of the fact that the setting value of the setting item in the lower layer in the printing condition has been changed. Therefore, the user is likely to notice the change of the setting value of the setting item in the lower layer in the printing condition.

Further, in the print controller described above, if the setting value of the setting item in the lower layer in the printing condition has been changed after a previous change, the display controller may preferably change the display form of the setting item in the top layer of the printing condition based on elapsed time from time when the setting value of the setting item in the lower layer corresponding to the setting item in the top layer was changed to a latest setting value by the print setter.

if a setting value of a setting item in a lower layer in a printing condition is changed again in several days after the setting value of the setting item in the lower layer in the printing condition was changed in the past and if the setting item in the top layer in the printing condition remained in the previous display form applied at the time of the past change, the user would be likely to not notice that the setting value of the setting item in the lower layer in the printing condition was changed several days ago.

In this regard, according to the configuration described above, since the display form of a setting item in the top layer in a printing condition is changed in accordance with the date and time when a setting value of the setting item in a lower layer in the printing condition was changed to the latest one, the user is likely to notice the change of the setting value of the setting item in the lower layer in the printing condition.

Further, the print controller described above may preferably include a history storage that stores a change history of settings in the printing condition made by the print setter, and the print setter is configured to use a change history stored in the history storage to change settings in the printing condition to settings in a printing condition corresponding to the change history.

According to the configuration described above, settings in a printing condition stored in the history storage are used as settings in the current printing condition as they stand, which can reduce a labor for changing a setting value of a setting item in a printing condition when a user changes the current settings in the printing condition to the past settings in the printing condition.

Further, the print controller described above may preferably include: a history storage that stores a change history of settings in the printing condition made by the print setter; and a searcher that searches for a same settings as settings in a current printing condition from the change history, and the display controller may be configured to, if the settings in the current printing condition match settings in a past printing condition stored as the change history, change a display form of at least one of a setting item and a setting value in the current printing condition based on elapsed time from time when the settings in the past printing condition was changed.

if the user again changes a setting value of a setting item that was changed in the past, the display form of at least one of the changed setting item and the changed setting value is changed from a display form which reflects the time lapse from the past change to a display form which reflects the time lapse from the second change. Then, if a user changes the setting value back to the setting value changed in the past, the display form of at least one of the setting item and the setting value would become a display form which reflects the elapsed time from the time when the setting value was changed back to the setting value that had been changed in the past and which is different from a display form that reflects the time lapse from the past change. That is, the past change history in the display form of at least one of the setting item and the setting value would be deleted.

In this regard, according to the configuration described above, if a setting value of a setting item that was changed in the past is changed and the changed setting value of the setting item is then changed back to the past setting value, the display form of at least one of the changed setting item and the changed setting value can be changed by the searcher to a display form which reflects the time lapse from the past change. In such a way, the past change history for the display form of at least one of the setting item and the setting value is maintained. Thus, even if a user changes a setting value of a setting item in a printing condition, not only the setting value but also the display form thereof can be changed back to the original state. Therefore, convenience in a change operation of a printing condition is improved.

Further, in the print controller described above, the display controller may preferably cause a date of change of a setting value of a setting item in the printing condition to be indicated next to the changed setting value of the setting item.

According to the configuration described above, since a date of change of a setting value of a setting item in a printing condition is indicated next to the same setting value, the user is able to more accurately identify the date of change of the setting value of the setting item.

Further, in the print controller described above, the display controller may preferably cause a date of change of a setting item in the printing condition to be indicated in a pop-up form next to a setting value of the changed setting item.

According to the configuration described above, while a date of change is not indicated during a usual use, the date of change is indicated when the user intends to check the date of change of a setting item in a printing condition. Therefore, it becomes easier for a user to check a setting item or a setting value in a printing condition and accurately identify the date of change of the setting value of the setting item.

A printing apparatus according to another aspect of the invention includes: a printing assembly that performs printing on a medium; and the print controller described above that controls the printing assembly.

According to the configuration described above, the same advantages as in the print controller described above can be obtained in the printing apparatus.

### BRIEF DESCRIPTION OF THE DRAWINGS

The invention will be described with reference to the accompanying drawings, wherein like numbers reference like elements.

FIG. 1 is a block diagram illustrating a control configuration of one embodiment of a printing apparatus.

FIG. 2 is a schematic diagram illustrating an example of a print setting window displayed on a terminal accessing the printing apparatus.

FIG. 3 is a flowchart illustrating a procedure of a process of changing a display form.

FIG. 4 is a table illustrating a relationship between ranges of elapsed time and changes of the display form.

FIG. 5A is a table illustrating a part of setting items in a printing condition for respective layers, in particular, a table of a part of setting items that were changed in the past.

FIG. 5B is a table illustrating a part of setting items in a printing condition for respective layers, in particular, a table of a part of setting items that were changed after the time of FIG. 5A.

FIG. 6 is a schematic diagram illustrating an example of a state where a change history window is displayed in the print setting window displayed on the terminal.

FIG. 7 is a schematic diagram illustrating an example of a part of a print setting window displayed on a terminal accessing the printing apparatus of a modified example.

FIG. 8 is a schematic diagram illustrating an example of a part of a print setting window displayed on a terminal accessing the printing apparatus of a modified example.

### DESCRIPTION OF EXEMPLARY EMBODIMENTS

A printing apparatus of one embodiment will be described below with reference to the drawings. Note that the printing apparatus of the present embodiment is formed of an ink jet printer that performs printing by ejecting ink as an example of a liquid on a medium, for example. Further, the printer is a so-called serial printer in which a printing assembly is moved in a direction intersecting a transport direction of the medium to perform printing.

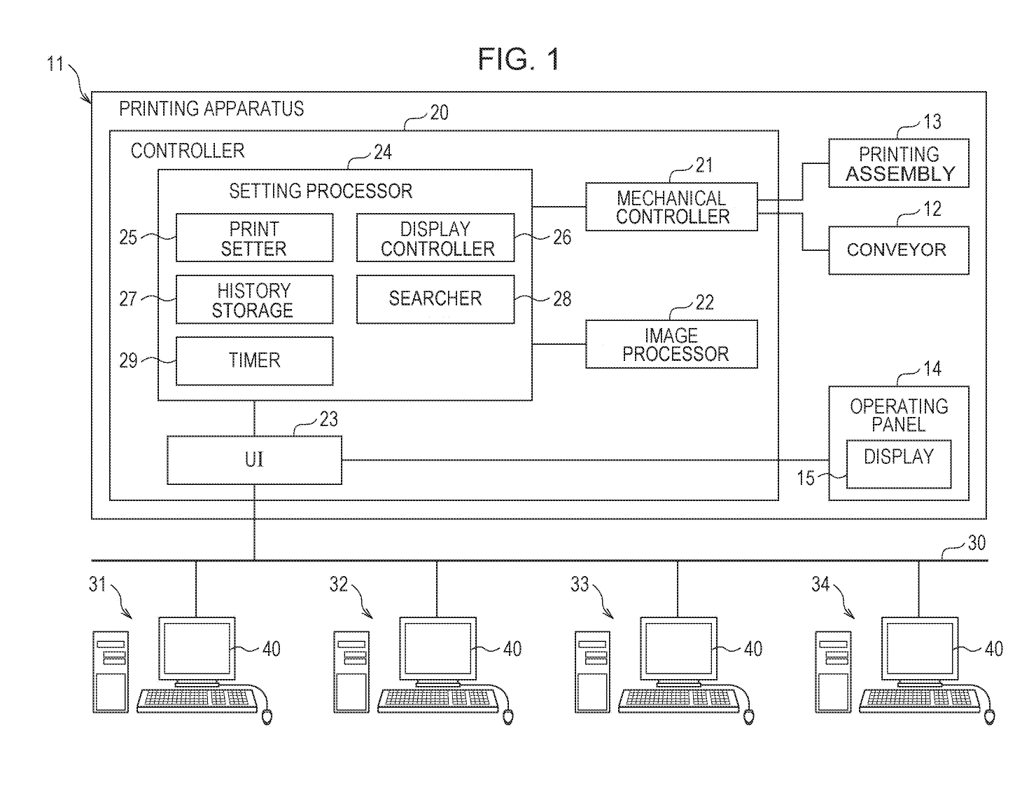

As illustrated in FIG. 1, a printing apparatus 11 is connected to a plurality of electronic terminals operated by a plurality of users via a network 30. In the present embodiment, four electronic terminals of a first terminal 31, a second terminal 32, a third terminal 33, and a fourth terminal 34 are connected to the printing apparatus 11. An example of these terminals 31 to 34 is a desktop personal computer as illustrated in FIG. 1. Note that each of the terminals 31 to 34 may be a mobile terminal such as a smartphone, a mobile information terminal (PDA (Personal Digital Assistants), a tablet personal computer, a laptop personal computer, or the like, instead of a desktop personal computer.

Each of the terminals 31 to 34 transmits, to the printing apparatus 11 via the network 30, an image to be printed on paper that is an example of a medium and/or a print job including a printing condition formed of various conditions for performing printing. The printing apparatus 11 performs printing on paper based on a print job from each of the terminals 31 to 34.

The printing apparatus 11 has a conveyor 12 that conveys paper to a printing area, a printing assembly 13 that performs printing on the paper conveyed by the conveyor 12 at the printing area, an operating panel 14 that is a liquid crystal panel on which print settings can be set from an instance other than each of the terminals 31 to 34, and a controller 20 that is an example of a print controller that controls the conveyor 12, the printing assembly 13, and the operating panel 14. The operating panel 14 has a display 15 on which information such as a printing condition is displayed.

The conveyor 12 drives a plurality of pairs of rollers (not depicted) by using electric motors (not depicted) and thereby conveys paper to the printing area while pinching the paper by the pairs of rollers. The printing assembly 13 has a carriage (not depicted) that reciprocates in a direction intersecting (preferably, orthogonal to) a conveying direction of paper conveyed by the conveyor 12, and ejects ink on the paper from a plurality of nozzles formed in an ejector (not depicted) mounted on the carriage. In the printing apparatus 11, transport of paper to the printing area by the conveyor 12 and ejection of ink on the paper by the printing assembly 13 are performed in an alternating manner and thereby an image or the like based on a print job received from one of the terminals 31 to 34 is printed on the paper.

The controller 20 has a CPU, a RAM, a ROM, and the like, and the CPU executes various control programs and/or processing programs stored in the ROM or the like. The controller 20 includes a mechanical controller 21, an image processor 22, a user interface (hereafter, referred to as “UI”) 23 that is an example of an receiver, a setting processor 24, and the like.

The mechanical controller 21 controls the conveyor 12 and the printing assembly 13 based on a print job. The image processor 22 performs, based on a print job, image processing such as a half-tone processing on an image transmitted to the printing apparatus 11.

The UI 23 includes software associated with setting and changing of a printing condition. The UI 23 receives a changing request for a printing condition from each of the terminals 31 to 34 via each of the terminals 31 to 34 connected to the network 30 and provides a function for communicating, for example, information associated with setting and changing of the printing condition with each user that is operating each of the terminals 31 to 34.

The setting processor 24 outputs information associated with setting and changing of a printing condition to the UI 23, changes the printing condition within the printing apparatus 11 based on a change request for the printing condition received by the UI 23, and stores a change history. This setting processor 24 includes a print setter 25, a display controller 26, a history storage 27, a searcher 28, and a timer 29.

The print setter 25 sets and changes a printing condition in the printing apparatus 11 based on an operation of setting and changing of the printing condition, in which the operation is generated by any terminal of the terminals 31 to 34 that accesses the UI 23 (hereafter, referred to as “accessing terminal”).

The display controller 26 outputs to the UI 23 data for causing a printing condition to be displayed on a screen 40 of the accessing terminal and data for causing a printing condition to be displayed on the display 15 of the operating panel 14. Further, the display controller 26 changes a display form of at least one of a setting item and a setting value of the changed printing condition in accordance with elapsed time from the time when the change of the printing condition was completed. In the present embodiment, a display form including the color of characters and the thickness of characters of a setting item or a setting value of a printing condition is changed. Note that the completion of a change of a printing condition refers to outputting of the changed printing condition to the UI 23 after a user operates an accessing terminal or the operating panel 14 to change the printing condition. Further, in an initial setting state of the printing apparatus 11, the display form of a setting item and a setting value of a printing condition (color of characters and thickness of characters) is “black and standard”.

Upon completion of a change of a printing condition in the printing apparatus 11 by the print setter 25, the history storage 27 stores the changed printing condition as a change history. When the number of change histories exceeds a preset threshold, the history storage 27 deletes the oldest change history of the stored change histories.

Upon completion of a change of a printing condition, the searcher 28 searches the history storage 27 for a change history of the printing condition and outputs the search result to the display controller 26.

Upon completion of a change of a printing condition, the timer 29 starts measurement of time to measure elapsed time from the completion of the change of the printing condition.

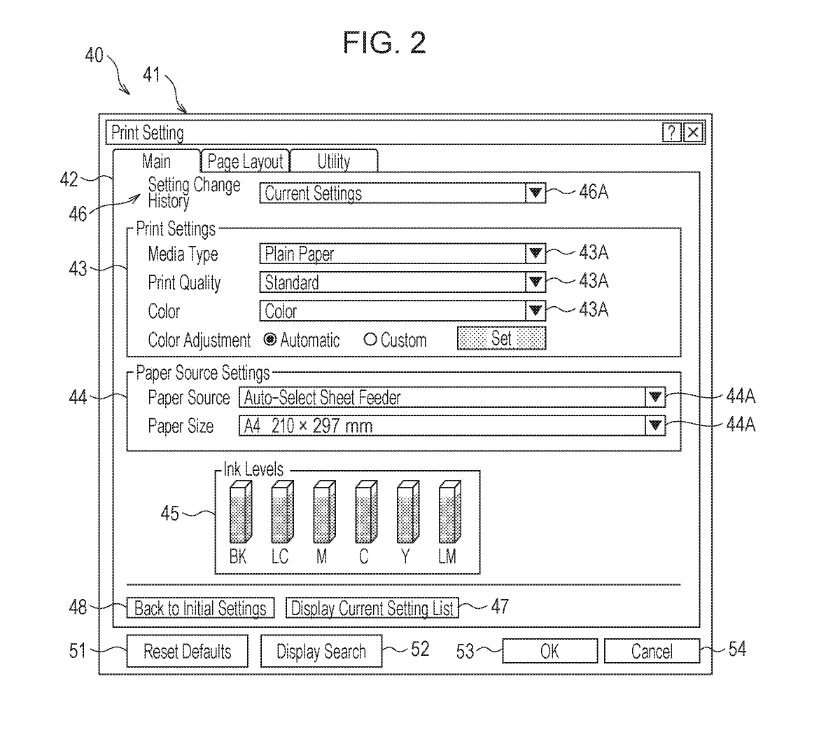

When any one of the terminals 31 to 34 accesses the UI 23 to perform a change operation on a printing condition, the controller 20 configured as described above causes a setting window 41 for setting and changing the printing condition as illustrated in FIG. 2 to be displayed on the screen 40 of the accessing terminal.

In the setting window 41 of FIG. 2, a tag window of main settings (hereafter, referred to as “main setting window 42”) is displayed. Note that, besides the main settings, the setting window 41 displays a page layout tag for setting a print direction, the number of copies, a print layout, and the like and a utility tag for performing a nozzle check, head cleaning, and the like and/or setting a printing operation and a transporting operation, and the like.

The main setting window 42 displays a print setting section 43, a paper source setting section 44, an ink level display section 45, a history display section 46, a setting list button 47, and an initial setting button 48.

The print setting section 43 includes setting items, “Media Type”, “Print Quality”, “Color”, and “Color Adjustment”, expressed using characters. Respective setting values (settings) of the setting items of media type, print quality, and color can be selected by a user pulling down respective choices 43A. In the choices 43A, setting values are expressed using characters.

The paper source setting section 44 includes setting items, “Paper Source” and “Paper Size”. Respective setting values (settings) of the setting items of paper source and paper size can be selected by a user pulling down choices 44A. In the choices 44A, setting values are expressed using characters.

The ink level display section 45 indicates the residual amount of ink for each color based on the ink amount filled in each polygonal container.

The history display section 46 indicates current and past printing conditions stored in the history storage 27. The past printing condition can be selected by a user pulling down a choice 46A. In the choice 46A, a date of change is expressed using characters, for example.

The setting list button 47 is a button for listing setting values of the current printing condition.

The initial setting button 48 is a button for changing the current printing condition to the initial printing condition. Note that the initial printing condition is a printing condition preset in the printing apparatus 11 before the printing condition is first changed by a user. For example, the initial printing condition is a printing condition that is set when the printing apparatus 11 is shipped from a factory. Note that the initial printing condition may be a printing condition that is set by a user as default values.

Further, under the main setting window 42, various buttons such as a display reset button 51, a display search button 52, an OK button 53, and a cancel button 54 are displayed.

The display reset button 51 is a button for resetting the current display form of the changed setting item (setting value). The display search button 52 is a button that, when the changed printing condition is the same as a printing condition set in the past, changes the display form to a display form that is based on the past printing condition. The OK button 53 is a button for verifying the current printing condition and/or the current display form. In response to a selecting operation on the OK button 53, a printing condition and/or a display form is outputted to the UI 23. The cancel button 54 is a button for cancelling a setting value of a setting item in a printing condition after a change made by a user.

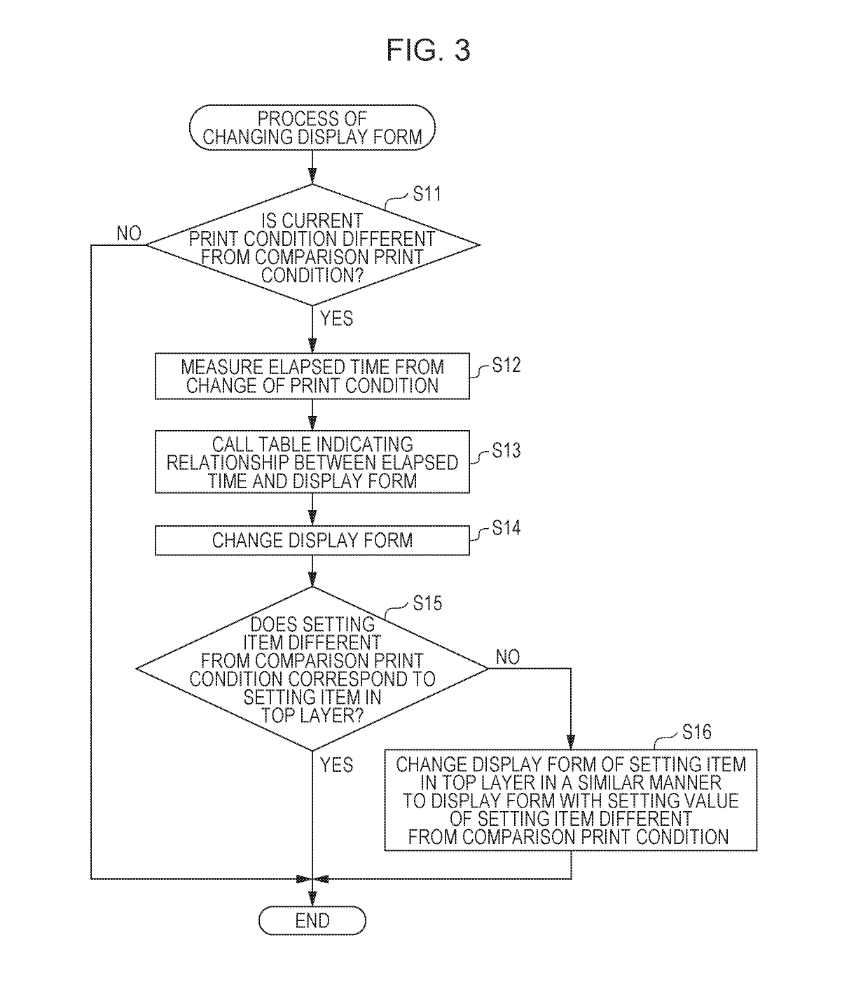

Further, the controller 20 performs a process of changing a display form for changing a display form of at least one of a setting item or a setting value in accordance with elapsed time from the time when the setting value of the setting item in a printing condition was changed. According to a procedure of a flowchart illustrated in FIG. 3, the process of changing a display form is performed upon completion of a change of a printing condition by a user or is repeatedly performed at a predetermined interval (for example, on a daily basis).

The procedure of the process of changing a display form will be described below along with its effect. Note that respective numbered components of the printing apparatus 11 in the illustration on and after FIG. 3 designate corresponding components of the printing apparatus 11 of FIG. 1.

As illustrated in FIG. 3, the controller 20 first determines whether or not the current printing condition is different from a comparison printing condition (step S11). Here, the current printing condition refers to a printing condition that has been set before the process of changing a display form is performed. Further, the comparison printing condition is the most recently changed printing condition or an initial printing condition if no change has been applied. Note that, in a state where, although a user changed a printing condition, the OK button 53 has not been pressed down and thus the change has not yet been reflected as a printing condition, the current printing condition may be a printing condition held by the UI 23. Further, in the case where whether or not printing has been performed is important in deciding a comparison printing condition, a printing condition applied when printing is last performed may be the comparison printing condition, regardless of whether or not the OK button 53 has been pressed down.

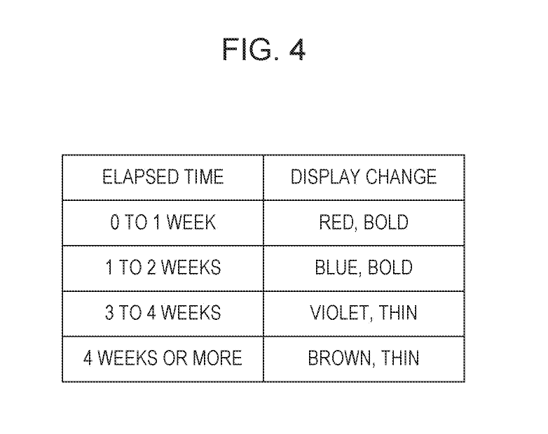

When the current printing condition is different from the comparison printing condition (step S11, YES), the controller 20 measures elapsed time from the completion of the change of the printing condition (step S12). This elapsed time is measured by the timer 29. The controller 20 then calls a table that indicates ranges of elapsed time and display forms as illustrated in FIG. 4 (step S13) and uses this table to change a display form of the changed setting item or the changed setting value in the printing condition after the change (step S14).

As illustrated in FIG. 4, the controller 20 changes a display form such as the color and thickness of characters of a setting item or a setting value in accordance with the elapsed time. Specifically, the controller 20 changes the display form of a setting item or a setting value to “red and bold” when the elapsed time ranges from “zero to one week” and changes the display form of a setting item or a setting value to “blue and bold” when the elapsed time ranges from “one to two weeks”. Further, the controller 20 changes the display form of a setting item or a setting value to “violet and thin” when the elapsed time ranges from “two to three weeks” and changes the display form of a setting item or a setting value to “brown and thin” when the elapsed time ranges from “four weeks or more”.

Next, the controller 20 determines whether or not, in the current printing condition, a setting item different from that in the comparison printing condition is a setting item in the top layer (step S15). When the setting item different from that in the comparison printing condition is not a setting item in the top layer, that is, when there is a setting item that is different from the setting item different from that in the comparison printing condition (step S15, NO), the controller 20 then causes the display controller 26 to change the display form of the setting item in the top layer in a similar manner to the setting item different from that in the comparison printing condition (step S16).

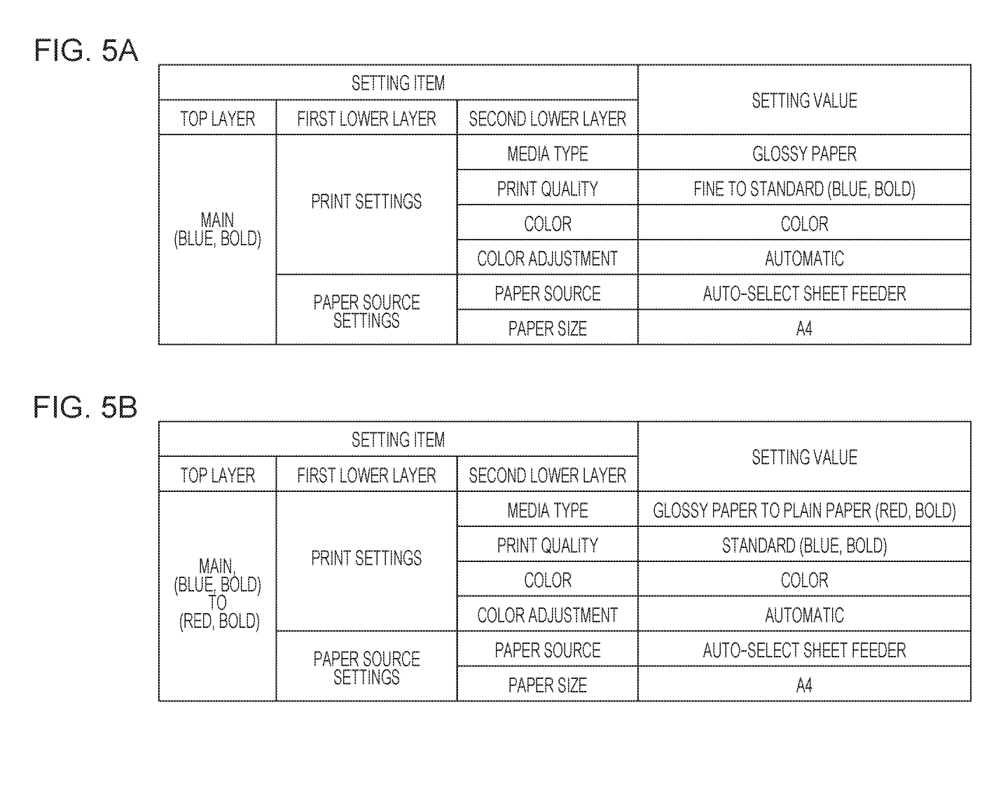

For example, as illustrated in FIG. 5A, assuming that a setting item, “Print Quality”, is changed from a setting item, “Fine”, to a setting item, “Standard”, ten days ago, the display form of the characters of “Standard” is changed from “red and bold” to “blue and bold”, because, in the current printing condition, ten days have elapsed from the time when there was a state different from the comparison printing condition. In response, the display form of the characters of “Main” that is the setting item in the top layer is changed from “red and bold” to “blue and bold”. Thus, by checking the display form of “Main”, the user viewing the setting window 41 is able to identify that “Main” has been changed and that “Main” was changed one to two weeks ago. Then, by selecting “Main” to cause the main setting window 42 to be displayed on the accessing terminal, the user is able to identify that “Print Quality” has been changed and that “Print Quality” was changed one to two weeks ago.

For example, as illustrated in FIG. 5B, assuming that a setting item, “Media Type”, in the current printing condition is changed from a setting value, “Glossy Paper”, to “Plain Paper”, the display form of the characters of “Plain Paper” is changed from “black and standard”, which is the initial settings in the printing apparatus 11, to “red and bold”. In response, the display form of the characters of “Main”, which is the setting item in the top layer, is changed from “blue and bold” to “red and bold”. In such a way, since the display form of a setting item in the top layer is changed in accordance with the latest time of change, it becomes easier for a user to identify that a setting value of a setting item in a lower layer included in the setting item in the top layer has been changed.

Further, when the current printing condition is the same as the comparison printing condition (step S11, NO) and when, in the current printing condition, a setting item different from the comparison printing condition is the setting item in the top layer (step S15, YES), the controller 20 ends the process. Note that, a situation where the current printing condition is the same as the comparison printing condition can be, for example, a situation where a user selected the initial setting button 48 to change a printing condition back to the initial state and pressed down the display reset button 51 to change the display form of a setting item and a setting value in the printing condition back to “black and standard” and this state has been maintained. Otherwise, the situation where the current printing condition is the same as the comparison printing condition can be a situation where the user has not made any change to the initial printing condition. In this case, the display form of the setting item and the setting value in the printing condition remains “black and standard”.

Next, another method of a change operation of a printing condition and another method of changing a display form of a setting item or a setting value will be described.

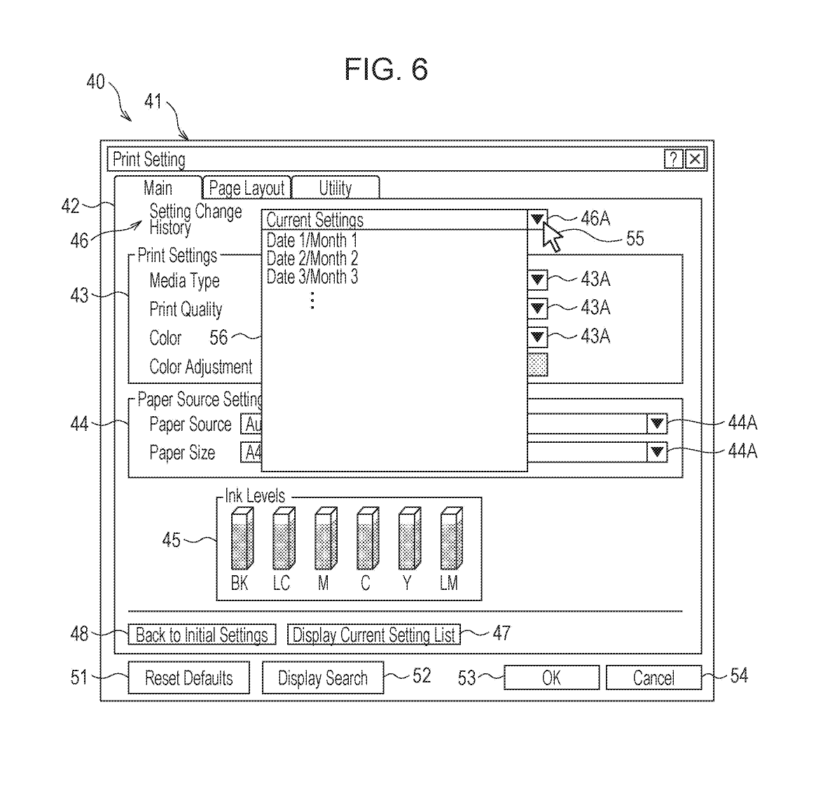

In response to completion of a change of a printing condition by a user, the controller 20 stores the changed printing condition in the history storage 27 and causes the display controller 26 to output the printing condition stored in the history storage 27 to the UI 23. Thus, upon a user's selecting operation on the choice 46A of the history display 46 in the main setting window 42 as illustrated in FIG. 6 by using a cursor 55, the history window 56 that indicates a list of change histories of the printing condition is displayed. A date of change is indicated in FIG. 6 as an example of a change history. In response to the user selecting a date of change in the history window 56, the print setter 25 then changes the printing condition to a printing condition corresponding to the date of change selected in the history window 56 and the display controller 26 displays the changed printing condition on the main setting window 42.

At this time, in the process of changing a display form, the controller 20 compares a setting value of each setting item of a printing condition which was applied before the changing operation, to a setting value of each setting item of the printing condition which corresponds to the selected date and time of change, and changes the display form of the changed setting items or the changed setting value to “red and bold”.

Further, when the display reset button 51 is selected by a user, the controller 20 changes all the display forms of setting items and setting values in a printing condition to the default state of “black and bold”. When the display search button 52 is selected by a user, the controller 20 then changes the display form of a setting item and a setting value in a printing condition to a display form of the setting item and the setting value applied before the display reset button 51 was operated. In details, when the display rest button 51 is operated, the searcher 28 searches for a past printing condition that matches the current printing condition. In this case, the display reset button 51 only is operated while the printing condition has not been changed, the searcher 28 outputs to the display controller 26 the printing condition and the display form applied before the operation of the display reset button 51. The display controller 26 then causes the printing condition and the display form applied before the operation of the display reset button 51 to be displayed on the main setting window 42.

According to the printing apparatus 11 of the present embodiment, the following advantages can be obtained.

(1) A user that changed a printing condition is likely to remember the date and time at which the user changed the printing condition by the user himself/herself. Therefore, with being able to identify that a printing condition was changed at a date and time which is different from the date and time when the user changed the printing condition by the user himself/herself, the user can determine whether the change of the printing condition was made by the user himself/herself or by another user.

In this regard, the printing apparatus 11 causes the display controller 26 to change the display form of a setting item or a setting value in a printing condition in accordance with elapsed time. This enables a user to identify when the printing condition was changed. Therefore, when the setting value of the setting item in the printing condition has been changed, the user is able to easily determine whether the change was made by the user himself/herself or by another user. Thus, the user is able to determine whether or not a setting value of a setting item in a print condition is the desired setting value. This can reduce a mistake in printing due to a change of a printing condition.

(2) The printing apparatus 11 causes the display controller 26 to change a display form of the color and the thickness of a display form of a setting item or a setting value of a printing condition. Therefore, a user is able to intuitively identify when a setting value of a setting item in a printing condition was changed, compared to the case where the date and time of change of the setting value of the setting item in the printing condition is displayed by the user's selecting operation to the setting item or the setting value in the printing condition, for example.

(3) When a setting value of a setting item in a lower layer in a printing condition is changed and unless the display form of the setting item in an upper layer in the printing condition were changed, the user would be likely to finish its setting operation of the printing condition without knowing the change of the setting value of the setting item in the lower layer in the printing condition.

In this regard, the printing apparatus 11 changes a setting value of a setting item in a lower layer in a printing condition and also changes the display form of the setting item on the top layer in the printing condition. Therefore, through the setting window 41, the printing apparatus 11 can inform a user of the fact that the setting value of the setting item in the lower layer in the printing condition has been changed. The user is therefore likely to notice the change of the setting value of the setting item in the lower layer in the printing condition.

(4) When a setting value of a setting item in a lower layer in a printing condition is changed again in several days after the setting value of the setting item in the lower layer in the printing condition was changed in the past and if the setting item in the top layer in the printing condition remained in the previous display form applied at the time of the past change, the user would be likely to not notice that the setting value of the setting item in the lower layer in the printing condition was changed several days ago.

In this regard, the printing apparatus 11 changes the display form of a setting item in the top layer in a printing condition in accordance with the date and time at which a setting value of the setting item in a lower layer in the printing condition was changed to the latest setting value. Therefore, the user is likely to notice that the setting value of the setting item in the lower layer in the printing condition has been changed.

(5) The printing apparatus 11 has the history storage 27, which stores a change history of a printing condition, and can change settings in a printing condition to settings in a printing condition in the change history by using the change histories in the history storage 27. Therefore, settings in a printing condition stored in the history storage 27 are used as the current settings in the printing condition as then stand, which can reduce a labor for changing a setting value of a setting item in the printing condition when a user changes the current settings in the printing condition to the past settings in the printing condition.

(6) When a user changes a setting value of a setting item changed in the past in a printing condition and then again changes the setting value back to the original setting value, the display form of the changed setting item or the changed setting value, that is, the setting item or the setting value that was changed back would become “red and bold” and a history of the display form would be deleted. In such a case, there would be likelihood that the user cannot identify which setting item was changed in the past before the change of the printing condition and cannot identify the elapsed time for the changed setting item.

To address this, when changing a setting value of a setting item changed in the past and then again changing the setting value back to the original setting value, the printing apparatus 11 causes the searcher 28 and the display controller 26 to change the display form to a display form that is based on the time lapse from the past change. Thus, since the past change history in the setting item is maintained, the display form can also be changed back to the original state even when the user changed the setting item in the printing condition. This improves the convenience in a change operation of a printing condition.

The present embodiment may be modified to the following different embodiments.

While a display form including the color and the thickness of characters of a setting item or a setting value is changed as illustrated in FIG. 4 by using the display controller 26 in the embodiment described above, a way of changing the display form of a setting item or a setting value is not limited thereto. For example, as a display form, at least one of a font type, a character style, a font size of characters, and a background color of at least one of a setting item and a setting value may be changed. Further, at least one of a setting item and a setting value may be highlighted in reverse video. That is, any way of change may be employed as long as it enables a user to visually determine that a display form of at least one of a setting item and a setting value is changed in accordance with the elapsed time from the change operation.

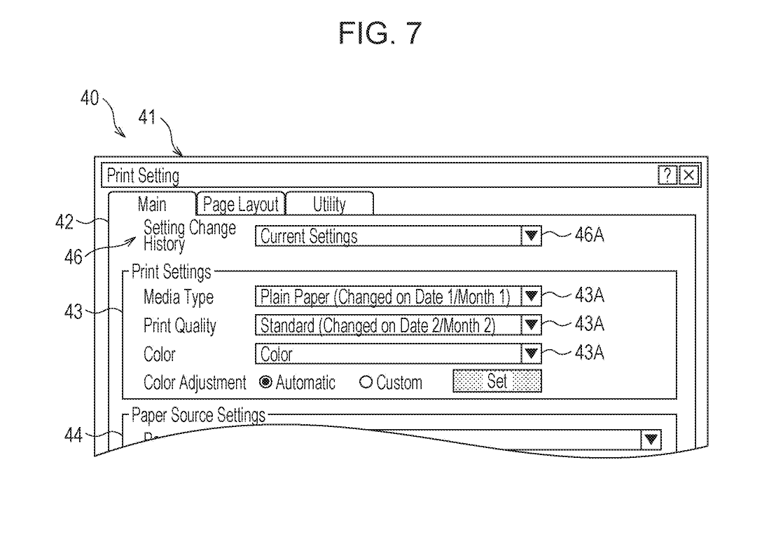

Further, instead of or in addition to a change of the display form of characters of a setting item or a setting value, the date of change may be indicated next to the setting value as illustrated in FIG. 7. FIG. 7 illustrates that, when setting values for the print quality and the media type are changed, the dates of change are indicated right to the setting values for the print quality and the media type. According to this configuration, the display of a date of change of a setting item next to a setting value enables a user to accurately identify the date of change of the setting item.

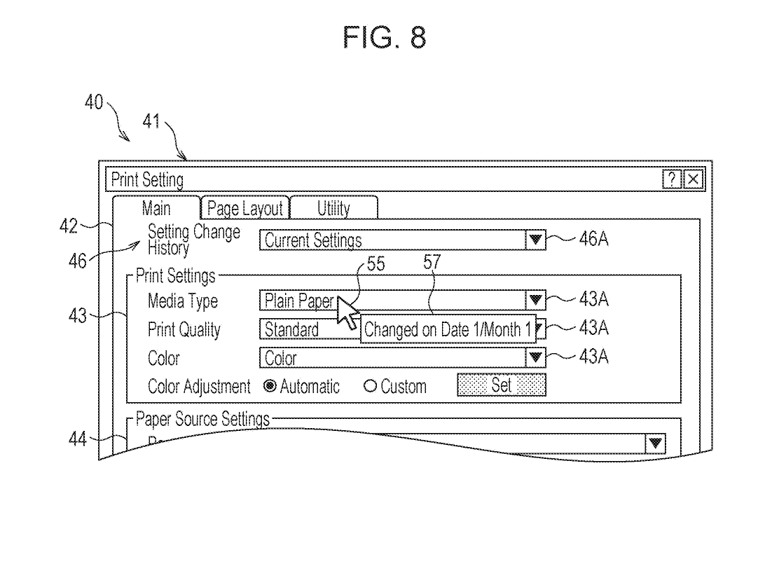

Further, instead of the display form of the date of change as seen in FIG. 7, as illustrated in FIG. 8, a change date window 57 may be displayed in a pop-up form in response to a user placing the cursor 55 at a setting item. In indicating the date of change as illustrated in FIG. 7 and FIG. 8, the display controller 26 outputs data of the date of change to the UI 23 and thereby the change date window 57 is displayed on the main setting window 42 of an accessing terminal. This configuration enables the user to accurately identify a date of change of a setting item. In addition, since a date of change is indicated when the user intends to check the date of change of the setting item, the absence of the display of the date of change in a usual setting window 41 allows for an easier view of setting values of print settings. Note that, in FIG. 7 and FIG. 8, a date and time of change may be indicated instead of a date of change.

While a display form of a setting item or a setting value is changed on a week basis in the embodiment described above, the length of the elapsed time is not limited thereto. For example, the length of the elapsed time may be shorter than a week such as a day or two to three days. Further, the length of the elapsed time may be able to be set by the user.

In the embodiment described above, not only the display form of a setting item in the top layer but also the display form of a setting item in a layer upper than the layer of the changed setting item may be changed. For example, when a setting value of a setting item of “Media Type” and/or “Print Quality” in the second lower layer is changed as illustrated in FIG. 5A and FIG. 5B, the display form of a setting item of “Print Settings” in the first lower layer may be changed.

While the display form of a setting value of a setting item such as “Media Type” and/or “Print Quality” in the second lower layer is changed in the embodiment described above, without limited to the above, the display form of the setting item may be changed instead of the display form of the setting value.

While the display form of a setting item in the top layer is changed in accordance with the elapsed time every time when a setting item in a lower layer included in the setting item in the top layer is changed in the embodiment described above, the change of the display form of the setting item in the top layer is not limited thereto. For example, the display controller 26 may change the setting item of the top layer to a preset display form only (for example, change the background color to yellow).

In the embodiment described above, when a setting item in a lower layer included in a setting item in the top layer is changed, the display form of the setting item in the top layer may not be changed.

In the embodiment described above, at least one of the history storage 27 and the searcher 28 may be omitted from the setting processor 24.

In the embodiment described above, the printing apparatus 11 may be a dot-impact printer or a laser printer as long as it can perform printing on a medium. Further, the printing apparatus 11 is not limited to the configuration having a printing function only, but may be a multi-function printer. Furthermore, the printing apparatus 11 is not limited to a serial printer, but may be a line printer or a page printer.

The medium is not limited to paper, but may be continuous forms, a resin film, a metal foil, a metal film, a compound film formed of a resin and a metal (a laminated film), fabrics, cloth, a ceramics sheet, or the like.

What is claimed is:

1. A print controller comprising:
a print setter configured to change a printing condition to a changed printing condition;
a receiver that receives the changed printing condition; and
a display controller that outputs the changed printing condition to the receiver,
wherein the display controller changes a display form of at least one of a setting item and a setting value of the changed printing condition in accordance with an elapsed time from a time when the printing condition was changed by the print setter.

2. The print controller according to claim 1, wherein the display controller indicates at least one of a setting item and a setting value of the changed printing condition by characters and changes the display form of at least one of color of the characters, a thickness of the characters, a background color of the characters, a font type of the characters, and a font size of the characters in accordance with the elapsed time.

3. The print controller according to claim 1,
wherein the printing condition is formed of layered setting items, and
wherein, if a setting value of a setting item in a lower layer of the printing condition is changed by the print setter, the display controller changes a display form of at least one of the setting item and the setting value in the lower layer and a display form of a setting item in a top layer of the printing condition.

4. The print controller according to claim 3, wherein, if the setting value of the setting item in the lower layer in the printing condition has been changed after a previous change, the display controller changes the display form of the setting item in the top layer of the printing condition based on an elapsed time from a time when the setting value of the setting item in the lower layer corresponding to the setting item in the top layer was changed to a latest setting value by the print setter.

5. The print controller according to claim 1 further comprising:
a history storage that stores a change history of settings in the printing condition made by the print setter,
wherein the print setter is configured to use a change history stored in the history storage to change settings in the printing condition to settings in a printing condition corresponding to the change history.

6. The print controller according to claim 1 further comprising:
a history storage that stores a change history of settings in the printing condition made by the print setter; and
a searcher that searches for settings identical to settings in a current printing condition from the change history,
wherein the display controller is configured to, if the settings in the current printing condition match settings in a past printing condition stored as the change history, change a display form of at least one of a setting item and a setting value in the current printing condition based on an elapsed time from a time when the settings in the past printing condition was changed.

7. The print controller according to claim 1, wherein the display controller causes a date of change of a setting value of a setting item in the printing condition to be indicated next to the changed setting value of the setting item.

8. The print controller according to claim 1, wherein the display controller causes a date of change of a setting item in the printing condition to be indicated in a pop-up form next to a setting value of the changed setting item.

9. A printing apparatus comprising:
the print controller according to claim 1; and
a printing assembly that performs printing on a medium,
wherein the print controller controls the printing assembly.
